(19) United States
(12) Patent Application Publication
(10) Pub. No.: US 2026/0027894 A1
(43) Pub. Date: Jan. 29, 2026

(54) CALIBRATION OF A GESTURE RECOGNITION ALGORITHM FOR THE GESTURE-CONTROLLED OPENING OF AN AREA OF A VEHICLE CLOSED BY A MOVABLE COMPONENT

(71) Applicant: VALEO SCHALTER UND SENSOREN GMBH, Bietigheim-Bissingen (DE)

(72) Inventors: Niko Moritz Scholz, Kronach Neuses (DE); Maximilian Poepperl, Kronach Neuses (DE)

(73) Assignee: VALEO SCHALTER UND SENSOREN GMBH, Bietigheim-Bissingen (DE)

(21) Appl. No.: 18/993,449

(22) PCT Filed: Jul. 10, 2023
(86) PCT No.: PCT/EP2023/068994

§ 371 Date: Jan. 10, 2025

(30) Foreign Application Priority Data
Jul. 12, 2022 (DE) 10 2022 117 274.0

(51) Int. Cl. B60K 35/10; G06F 3/01

(52) U.S. Cl. CPC B60K 35/10; G06F 3/017; B60K 2360/1464; B60K 2360/797

(57) ABSTRACT

According to a method for calibrating a gesture recognition algorithm for the gesture-controlled opening of an area of a vehicle (1) closed by a movable component (3), a gesture recognition algorithm is provided in a computer-readable format which is adapted to recognize a predetermined gesture as a function of a time-dependent sensor signal of an ultrasonic sensor (5) of the vehicle (1). A time-dependent first sensor signal is generated by means of the ultrasonic sensor (5) while a first person (8) performs a gesture movement in a field of view of the ultrasonic sensor (5) and a first value of a predetermined parameter of the gesture recognition algorithm is determined and stored as a function of the first sensor signal.

The present invention relates to a method for calibrating a gesture recognition algorithm for the gesture-controlled opening of an area of a vehicle closed by a movable component. The invention furthermore relates to a method for the gesture-controlled opening of an area of a vehicle closed by a movable component and to a corresponding device for a vehicle and to a computer program product.

Devices for automatically opening trunk lids or tailgates of vehicles are known, when a user brings a leg, for example, into a target area designated for this in the vicinity of the vehicle. For this purpose, capacitive sensors, for example, are employed in order to detect the presence of the leg in the target area.

A disadvantage of this is that these devices react relatively unspecifically, and therefore there is a danger of false-positive detection if another object is brought into the target area, for instance, without the user correspondingly intending to automatically open the trunk lid or tailgate. In order to counteract this, the device can be configured in such a way, for example, that the target area is appropriately small and therefore the probability of an object unintentionally being brought into the target area is reduced. However, this is also disadvantageous because the user, if automatic opening of the trunk lid or tailgate is actually desired, must enter a relatively small target area, which in turn means that reliability in recognizing the intention of the user is reduced.

Furthermore, it is known to use ultrasonic sensors for gesture recognition. Since the spacing of an object from the ultrasonic sensor can be evaluated in a time-dependent manner by means of an ultrasonic sensor, the time profile of a leg of the user, for example, and accordingly a gesture which the user performs with the leg, can also be recognized and characterized by means of ultrasonic sensors.

However, when ultrasonic sensors are used for gesture recognition, in principle it can also arise that a corresponding movement of the user is not recognized as a gesture, since the movement can differ in details, for example, depending on the person or the user.

Document DE 10 2016 013 935 A1 describes a method for automatically carrying out vehicle functions. In that case, a user is recognized via a vehicle key and subsequently gestures or behavioral patterns are recorded via one or more vehicle cameras. A vehicle setting can be personalized as a function of this, for example a seating position can be set in a correspondingly personalized manner.

It is an object of the present invention to specify a possibility for contactlessly opening an area of a vehicle closed by a movable component of the vehicle, by which possibility the intention of the user to open can be recognized reliably.

This object is achieved by the respective subject matter of the independent claims. Advantageous developments and preferred embodiments are the subject matter of the dependent claims.

The invention is based on the idea of calibrating a predetermined gesture recognition algorithm for ultrasound-based gesture recognition, by determining and storing a value of a predetermined parameter of the gesture recognition algorithm as a function of a sensor signal which an ultrasonic sensor of the vehicle generates while a person performs a gesture movement.

According to one aspect of the invention, a method for calibrating a gesture recognition algorithm for the gesture-controlled opening of an area of a vehicle, in particular a motor vehicle, closed by a movable component is specified. A gesture recognition algorithm is provided in a computer-readable format. The gesture recognition algorithm is adapted to recognize a predetermined gesture as a function of a time-dependent sensor signal of an ultrasonic sensor of the vehicle. A time-dependent first sensor signal is generated by means of the ultrasonic sensor while a first person performs a gesture movement in a field of view of the ultrasonic sensor. A first value of a predetermined parameter of the gesture recognition algorithm is determined and stored, in particular adapted, as a function, in particular by means of at least one computing unit.

The ultrasonic sensor and optionally further ultrasonic sensors of the vehicle can be part of an ultrasonic sensor system of the vehicle, for example. The ultrasonic sensor system can also have at least one computing unit which can activate the ultrasonic sensor and can determine and store the first value of the predetermined parameter as a function of the first sensor signal.

The ultrasonic sensor system can be operated in a calibration mode, for example, and the first sensor signal can be generated in the calibration mode. Besides this, the ultrasonic sensor system can be operated in a gesture recognition mode, for example, in particular after the first value of the parameter has been determined and stored. The gesture recognition algorithm is adapted in particular to recognize the gesture in the gesture recognition mode as a function of the sensor signal of the ultrasonic sensor.

The at least one computing unit can activate the ultrasonic sensor to emit ultrasonic waves and, for example, activate or deactivate the calibration mode and/or the gesture recognition mode.

The ultrasonic waves can be emitted by the ultrasonic sensor in the form of one or more ultrasonic pulses, for example. Portions of the emitted ultrasonic waves reflected in the environment and detected by the ultrasonic sensors prompt the ultrasonic sensor to generate the sensor signal or the first sensor signal, in particular as an electrical signal or voltage signal or current signal. The ultrasonic sensor can also be referred to as an ultrasonic transducer.

The first sensor signal can, for example, correspond to an amplitude or intensity of the ultrasonic waves reflected and detected in each case at a certain point in time or a corresponding envelope.

Since the first person is situated in the field of view of the ultrasonic sensor and performs the gesture movement, the first sensor signal therefore mirrors the gesture movement or is generated as a function of the gesture movement. The gesture movement can be interpreted as the movement of a body part, in particular of a leg or knee, of the first person, which movement represents or is intended to represent or is intended to replicate the predetermined gesture. During the performance of the gesture movement, the first person can be situated in a predefined gesture recognition area outside of the vehicle, for example, in particular in the immediate vicinity of the ultrasonic sensor, wherein the field of view of the ultrasonic sensor covers the gesture recognition area.

After the determination and storage of the first value for the parameter, the calibration mode can be deactivated, for example. The gesture recognition mode can then be activated, for example. The determination and storage, in particular adaptation, of the first value of the parameter of the gesture recognition algorithm can be understood as calibration of the gesture recognition algorithm. After the method according to the invention for calibrating the gesture recognition algorithm has been carried out, the gesture recognition can be used to recognize the predetermined gesture as a function of the first value of the parameter. In an analogous manner, further parameters of the gesture recognition algorithm can also be determined and stored as a function of the first sensor signal and used for further use of the gesture recognition algorithm in the gesture recognition mode.

Since the first value of the parameter is determined in a person-related manner as a function of the gesture movement of the first person, characteristic movement patterns or properties of the gesture movement of the first person can be taken into account, for example, for the later gesture recognition in the gesture recognition mode. For example, the gesture recognition algorithm in principle can already be capable of detecting the gesture as a function of a sensor signal of the ultrasonic sensor even before the method for calibration according to the invention has been carried out. However, person-dependent properties of the gesture movement are taken into account by the method according to the invention and the gesture recognition mode is adapted accordingly. As a result, the reliability of the gesture recognition in the gesture recognition mode can be increased. In other words, the probability of the first person wishing to perform the gesture but this not being recognized by the gesture recognition algorithm due to characteristic properties of the movement of the first person can be reduced.

According to at least one embodiment of the method for calibrating the gesture recognition algorithm, a characteristic property of the gesture movement regarding the first person is determined as a function of the first sensor signal, in particular by means of the at least one computing unit, and the first value of the parameter is determined, in particular by means of the at least one computing unit, as a function of the characteristic property determined regarding the first person.

The characteristic property can, for example, be an initial spacing of a body part of the first person moved during the gesture movement or the characteristic property can be derived therefrom. Therefore, advantageously it can be taken into account that different persons typically adopt different spacings from the vehicle when they perform the gesture movement.

Likewise, the characteristic property can correspond to a final spacing of the body part after or upon completion of the gesture movement or be derived therefrom.

The gesture movement can correspond to a movement of the body part, for example, in particular the leg, from a starting position in the direction of the vehicle or the ultrasonic sensor and back to the starting position or approximately to the starting position. The spacing of the body part from the ultrasonic sensor is therefore equal to the initial spacing, in particular at the beginning of the gesture movement, is then reduced and thereafter increased again until the final spacing is reached.

By taking the final spacing into account, it can be taken into account that different persons typically make a movement or take a step toward the ultrasonic sensor, for example, when they perform the gesture movement. In other words, persons possibly do not return the leg completely to the starting position and to the initial spacing, and therefore the final spacing does not match the initial spacing. This can be utilized for the person-specific characterization and corresponding person-specific determination of the first value for the parameter.

The characteristic property can also correspond to a distance between the final spacing and the initial spacing or be derived therefrom.

The characteristic property can also correspond to a speed of movement of the body part during the gesture movement or be derived therefrom.

Advantageously, therefore, it can be taken into account that different persons typically move the body part at different speeds in order to perform the gesture movement.

The characteristic property can correspond to a time duration of the gesture movement or be derived therefrom. The time duration can also be used to map and take into account person-specific characteristics of the gesture movement, for example the different speed of the gesture movement and also person-specific body proportions such as the length of the leg and so on.

The characteristic property can also correspond to an amplitude, in particular a maximum amplitude, of a signal pulse of the first sensor signal during the gesture movement or be derived therefrom. The maximum amplitude can be influenced by, amongst other things, the body size, build or clothing of the first person, for example, which are further typical variables influencing the characteristic of the gesture movement or the first value of the parameter.

The characteristic property is not limited to the examples mentioned. Several of the characteristic properties mentioned, or others, can be determined on the basis of the first sensor signal, and the first value of the parameter can be determined as a function of these. Two or more characteristic properties can also be combined with one another or offset against one another in order to determine the first value for the parameter.

In general, the parameter can correspond directly to one of the characteristic properties or be derived from one or more of the characteristic properties.

By taking the characteristic property as the basis for determining the first value for the parameter, the gesture recognition algorithm can be influenced in a targeted manner in order to increase the reliability of the gesture recognition. As a result, the first value of the parameter can be determined in particular in such a way that the gesture recognition algorithm can take particularly relevant characteristic properties into account during the gesture recognition, and possibly less relevant characteristic properties are given no or less weight during the gesture recognition. In particular, this can prevent the gesture recognition algorithm from being over-specified and any variations in the gesture movement of one and the same person from being able to affect the reliability of the gesture recognition.

According to at least one embodiment, the generation of the first sensor signal is repeated while the first person repeatedly performs the gesture movement in the field of view of the ultrasonic sensor. The determination of the characteristic property of the gesture movement regarding the first person is likewise repeated on the basis of the repeatedly generated first sensor signal. The first value of the parameter is determined as a function of the repeatedly determined characteristic property, for example by averaging or some other statistical processing.

In this way, fluctuations in the characteristic property during performance of the gesture movement by one and the same person can be counteracted. As a result, the reliability of the gesture recognition can be further increased.

According to at least one embodiment, the gesture recognition algorithm implements a state machine.

The state machine presents an algorithm which can establish one of two or more predefined states, for example of the first sensor signal or of the gesture movement or of the first person, as a function of the first sensor signal, and in particular can detect the presence of the gesture on the basis of a time sequence of the states determined in this way.

For example, different states of the state machine can correspond to situations in which the body part is stationary in certain spacing ranges from the ultrasonic sensor and/or situations in which the body part is moved in a certain direction. In a non-limiting example, the gesture could therefore be detected, for example, if a state in which the body part is stationary in the gesture recognition area is followed by a state in which the body part is moved toward the ultrasonic sensor, this state in turn is followed by a state in which the body part is moved away from the ultrasonic sensor and this state in turn is followed by a state in which the body part in turn is stationary in the gesture recognition area.

The predetermined parameter and further parameters, for example, can be drawn upon to identify the individual states. For example, one or more characteristic properties can be used directly or processed as parameters for the state machine for recognizing the individual states. In this way, by specifying the first value for the parameter on a person-specific basis, it is possible to directly influence the state recognition by means of the state machine and, accordingly, the gesture recognition.

According to at least one embodiment, a time-dependent second sensor signal is generated by means of the ultrasonic sensor while a second person, who in particular is different than the first person, performs the gesture movement in the field of view of the ultrasonic sensor. The characteristic property of the gesture movement regarding the second person is determined, in particular by means of the at least one computing unit, as a function of the second sensor signal. A second value of the parameter is determined and stored, in particular by means of the at least one computing unit, as a function of the characteristic property determined regarding the second person.

Different values of the parameter or different variants of the gesture recognition algorithm which are assigned to different persons can therefore be stored and retained. For example, corresponding user profiles for different persons can be created, which user profiles store the respective value for the parameter or the correspondingly adapted gesture recognition algorithm. As a result, the reliability of the gesture recognition can be further increased.

According to at least one embodiment, the gesture recognition algorithm contains a trained recurrent neural network RNN, for example a long short term memory LSTM, and the parameter is a weighting factor or a bias parameter of the RNN.

In such embodiments, the gesture recognition algorithm can recognize the gesture directly, for example, on the basis of input data which are produced as a function of the sensor signal of the ultrasonic sensor, without the intermediate step of determining the characteristic property having to be carried out. This has the advantage that the person-specific differences in the gesture movement and the influence thereof on gesture detection do not necessarily have to be known.

In such embodiments, the method for calibrating the gesture recognition algorithm can be understood in such a way that the training of the RNN on the basis of the first sensor signal is improved or refined.

If the ultrasonic sensor system is in the calibration mode, for example, it can be assumed that the performed gesture movement actually corresponds to the gesture. Accordingly, the parameterization of the RNN can, if necessary, be adapted as a function of the first sensor signal, in order to increase the confidence with which the gesture based thereon is detected, for example.

According to at least one embodiment, a calibration mode of the ultrasonic sensor system is activated, for example by means of the at least one computing unit, and the first sensor signal is generated in the calibration mode. The calibration mode can be initiated by the first person, for example.

For example, at least one radio signal can be transmitted to the at least one computing unit by means of an electronic apparatus external to the vehicle and the calibration mode can be activated as a function of the transmitted at least one radio signal.

The electronic apparatus external to the vehicle, which is therefore in particular not part of the vehicle, may be equivalent to a mobile electronic terminal, a smartphone, a smartwatch or some other so-called wearable device or a vehicle key for the vehicle or a key chain or the like, for example. Therefore, the calibration mode can be initiated in particular if the first person notices that the reliability of the gesture detection needs to be improved.

According to at least one embodiment, identification information of the first person is transmitted to the at least one computing unit using the at least one radio signal. The first value of the parameter is stored in a user profile of the first person as a function of the identification information. The same applies to the second person, for example, in corresponding embodiments.

In different embodiments, the calibration mode can also be activated as a function of a user input recorded by means of a user input apparatus of the vehicle.

According to a further aspect of the invention, a method for the gesture-controlled opening of an area of a vehicle closed by a movable component is specified. A method according to the invention for calibrating the gesture recognition algorithm is carried out here. After the method for calibrating the gesture recognition algorithm has been carried out, a time-dependent further first sensor signal is generated by means of the ultrasonic sensor while the first person performs the gesture movement again in the field of view of the ultrasonic sensor, for example during the gesture recognition mode. By applying the gesture recognition algorithm to input data which are a function of the further sensor signal, a predetermined gesture is detected as a function of the stored first value, in particular by means of the at least one computing unit. In response to the detection of the gesture, the movable component is moved automatically in order to open the closed area.

In response to the detection of the gesture can be understood in such a way that the automatic movement of the movable component takes place only if the gesture has been detected. In other words, the input data are produced as a function of the further first sensor signal and the gesture recognition algorithm is applied to the input data as a function of the stored first value of the parameter, in order to detect the gesture.

The gesture recognition mode can be activated, for example, if the first person is situated in the gesture recognition area. However, further conditions for activating the gesture recognition mode can also be envisioned.

Since the further first sensor signal mirrors the spacing of the first person or the body part of the first person from the ultrasonic sensor, the performance of the gesture movement can therefore be recognized as the gesture and detected accordingly.

Depending on the embodiment of the method and of the vehicle, the movable component can be a door, for example, in particular a side door, a driver's door, a passenger door, a rear door, a back door, a sliding door, a tailgate or a trunk lid. It is preferably a tailgate or a trunk lid. In this case, the closed area of the vehicle is a trunk, for example, or an open or closed loading area of the vehicle. An open loading area can be open at the top, in particular, which does not exclude the open loading area from being closed in the rear direction by the tailgate, for example, such as in the case of a small van or a pickup truck with an open loading surface.

For application cases or application situations which may arise in the method and which are not explicitly described here, it can be envisioned that, according to the invention, an error message and/or a request for input of user feedback is output and/or a default setting and/or a prespecified initial state is set.

According to a further aspect of the invention, a device for a vehicle for the gesture-controlled opening of an area of the vehicle closed by a movable component is specified. The device has an ultrasonic sensor system with an ultrasonic sensor, wherein the ultrasonic sensor system is designed to generate a time-dependent first sensor signal by means of the ultrasonic sensor while a first person performs a gesture movement in a field of view of the ultrasonic sensor. The ultrasonic sensor system has at least one computing unit which is designed to determine and to store a first value of a predetermined parameter of a gesture recognition algorithm as a function of the first sensor signal.

A computing unit can be understood, in particular, to be a data processing apparatus which contains a processing circuit. The computing unit can therefore process data in particular for carrying out computing operations. Optionally, these also include operations for performing indexed accesses to a data structure, for example a look-up table (LUT).

The computing unit can in particular contain one or more computers, one or more microcontrollers, and/or one or more integrated circuits, for example one or more application-specific integrated circuits (ASIC), one or more field-programmable gate arrays (FPGA), and/or one or more systems-on-a-chip (SoC). The computing unit can also contain one or more processors, for example one or more microprocessors, one or more central processing units (CPU), one or more graphics processing units (GPU), and/or one or more signal processors, in particular one or more digital signal processors (DSP). The computing unit may also contain a physical or virtual group of computers or other types of the mentioned units.

In various exemplary embodiments, the computing unit contains one or more hardware and/or software interfaces and/or one or more storage units.

A storage unit can be configured as a volatile data memory, for example as a dynamic random access memory (DRAM) or a static random access memory (SRAM), or as a non-volatile data memory, for example as a read-only memory (ROM), as a programmable read-only memory (PROM), as an erasable programmable read-only memory (EPROM), as an electrically erasable programmable read-only memory (EEPROM), as a flash memory or flash EEPROM, as a ferroelectric random access memory (FRAM), as a magnetoresistive random-access memory (MRAM), or as a phase-change random-access memory (PCRAM).

According to at least one embodiment, the device has a storage medium which stores the gesture recognition algorithm in a computer-readable format. The ultrasonic sensor system is designed, after the determination and storage of the first value of the parameter, to generate a time-dependent further first sensor signal by means of the ultrasonic sensor while the first person performs the gesture movement again in the field of view of the ultrasonic sensor. The at least one computing unit is designed to apply the gesture recognition algorithm to input data which are a function of the further first sensor signal, as a function of the stored first value of the parameter, in order to detect a predetermined gesture. The at least one computing unit is designed to generate at least one control signal to automatically move the movable component in response to the detection of the gesture.

According to at least one embodiment, the device has at least one actuator which is designed to automatically move the movable component as a function of the control signal, in order to open the closed area.

The at least one computing unit can transmit the control signal directly to the at least one actuator or to a control unit for the at least one actuator, and the control unit for the at least one actuator generates a further control signal which it transmits to the at least one actuator in order to prompt this to move the movable component as a function of the further control signal.

If the present disclosure refers to a component of the device according to the invention, in particular the at least one computing unit of the device, as being designed, formed, configured or the like, to execute or realize a certain function, to achieve a certain effect or to serve a certain purpose, this can be understood in such a way that the component, beyond the fundamental or theoretical usability or suitability of the component for this function, effect or purpose, is specifically and actually capable of executing or realizing the function, achieving the effect or serving the purpose by an appropriate adaptation, programming, physical configuration and so on.

Further embodiments of the device according to the invention follow directly from the various configurations of the method according to the invention and vice versa. In particular, individual features and corresponding explanations and advantages regarding the various embodiments relating to the method according to the invention can be transferred in an analogous manner to corresponding embodiments of the device according to the invention. In particular, the device according to the invention is formed or programmed to carry out a method according to the invention. In particular, the device according to the invention carries out a method according to the invention.

According to a further aspect of the invention, a computer program containing instructions is specified. When the instructions are executed by a device according to the invention, in particular by the at least one computing unit, the instructions prompt the device to carry out a method according to the invention for calibrating the gesture recognition algorithm and/or a method according to the invention for the gesture-controlled opening of a closed area of a vehicle.

According to a further aspect of the invention, a computer-readable storage medium is specified, which stores a computer program according to the invention.

The computer program and the computer-readable storage medium can be interpreted as respective computer program products containing the instructions.

Further features of the invention can be found in the claims, the figures, and the description of the figures. The features and combinations of features mentioned above in the description and the features and combinations of features mentioned below in the description of the figures and/or shown in the figures can be included in the invention not only in the combination specified in each case, but also in other combinations. In particular, embodiments and combinations of features that do not have all the features of an originally worded claim can also be included in the invention. Furthermore, embodiments and combinations of features that go beyond or differ from the combinations of features set out in the back-references of the claims can be included in the invention.

The invention is explained in more detail below on the basis of specific exemplary embodiments with reference to associated schematic drawings. In the figures, identical or functionally identical elements may be provided with the same reference signs. The description of identical or functionally identical elements may not necessarily be repeated with respect to different figures.

In the figures:

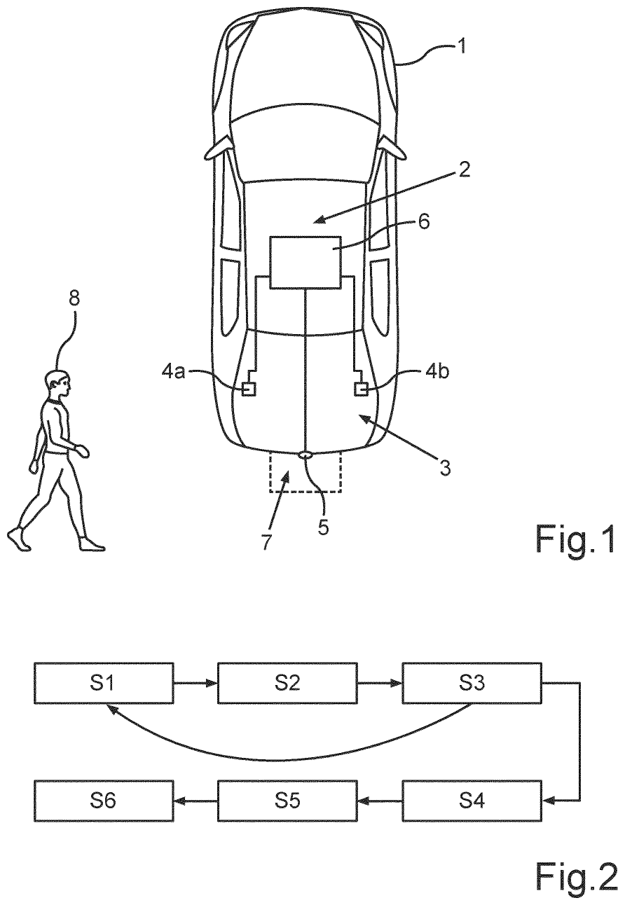

FIG. 1 shows a schematic depiction of a vehicle with an exemplary embodiment of a device for a vehicle for the automatic opening of an area of the vehicle closed by a movable component, according to the invention; and

FIG. 2 shows a schematic flowchart of an exemplary embodiment of a method for the automatic opening of an area of a vehicle closed by a movable component, according to the invention.

FIG. 1 schematically depicts a vehicle 1 with an exemplary embodiment of a device 2 according to the invention for the gesture-controlled opening of an area of the vehicle 1 closed by a movable component 3.

The movable component 3 is depicted here, by way of example, as a trunk lid of the vehicle 1, and therefore the area closed thereby is a trunk of the vehicle 1. In other embodiments, the movable component can instead also be a tailgate or a door of the vehicle 1.

The vehicle, for example the device 2, has in particular one or more, in the non-limiting example of FIG. 1 two, actuators 4a, 4b and a computing unit 6. The computing unit 6 can be regarded as being representative of one or more control, computing and/or evaluation units, which are described combined in functional terms to simplify the description. The computing unit 6 can activate in particular the actuators 4a, 4b, such that these for example automatically initiate a movement of the movable component 3 and optionally can release a lock of the movable component 3. As a result, the area of the vehicle closed by the movable component 3 can therefore be opened automatically, that is to say without a user having to manually open the movable component 3. Systems are known in which this can be released by means of a vehicle key for the vehicle 1. This may also be possible in the present device 2, but it is not strictly necessary. Rather, the device 2 can carry out a method according to the invention for the gesture-controlled opening of the closed area.

For this purpose, the device 2 has an ultrasonic sensor 5, which has a field of view in which it can detect objects such as a person 8. In particular, the ultrasonic sensor 5 can send out ultrasonic pulses and detect portions of the ultrasonic pulses reflected by an object in the field of view of the ultrasonic sensor 5 and, as a function thereof, can generate a correspondingly time-dependent sensor signal which reproduces the intensity of the detected portions of the ultrasonic pulses. The sensor signal then typically contains signal pulses, also referred to as peaks or echoes, wherein each signal pulse is based on an emitted ultrasonic pulse. The temporal position of the signal pulses enables the spacing of the reflected object from the ultrasonic sensor 5 to be determined by means of the computing unit 6.

The ultrasonic sensor 5 and the computing unit 6 or parts of the computing unit 6 can, as well as possibly further ultrasonic sensors (not shown), be interpreted as parts of an ultrasonic sensor system of the device 2. The ultrasonic sensor system, in particular the ultrasonic sensor 5, can be used not necessarily only in the sense of the invention, but rather additionally optionally also for other functions such as for parking support for a driver of the vehicle 1.

The method according to the invention for the gesture-controlled opening of the area of the vehicle 1 closed by the movable component 3 envisions that a method according to the invention for the calibration of a gesture recognition algorithm is carried out. The gesture recognition algorithm is stored, in particular, in a computer-readable format on a storage medium of the computing unit 6.

In a calibration mode which can be initiated by the person 8, for example, for example via a user input interface of the vehicle 1 or an electronic apparatus external to the vehicle, such as a smartphone, the person 8 can perform a gesture movement in the field of view of the ultrasonic sensor 5, for example in a predetermined gesture recognition area 7 in the vicinity of the ultrasonic sensor 5, for example move a leg from a standing position in the direction of the ultrasonic sensor 5 and back again. While the person 8 performs the gesture movement, the ultrasonic sensor 5 generates a corresponding time-dependent sensor signal. As a function thereof, the computing unit 6 determines a value of a predetermined parameter of the gesture recognition algorithm, in particular specifically for the person 8, and stores it.

For this purpose, the computing unit 6 can determine a characteristic property of the gesture movement regarding the person 8, for example, as a function of the sensor signal, and determine the value of the parameter as a function of the characteristic property.

Optionally, the person 8 can also perform the gesture movement repeatedly in order to compensate for fluctuations in the characteristic property.

After completion of the method for calibrating the gesture recognition algorithm, the same person 8 can in turn present themselves in the gesture recognition area 7 at a later point in time in a gesture recognition mode and perform the gesture movement again. The calibrated gesture recognition algorithm can now produce input data for the gesture recognition algorithm as a function of the correspondingly generated further sensor signal of the ultrasonic sensor, and apply the gesture recognition algorithm, in particular with the stored value of the parameter or as a function of the stored value of the parameter, to the input data. As a result, the gesture recognition algorithm can detect a predetermined gesture.

If the gesture was detected, the computing unit 6 can generate at least one control signal for the automatic movement of the movable component 3 and transmit it to the actuators 4a, 4b, such that the opening of the closed area is initiated.

For the gesture recognition itself, the computing unit 6 can use methods known per se. For example, the gesture recognition algorithm can implement a state machine. The computing unit 6, by applying the gesture recognition algorithm to the input data, can therefore then recognize when the gesture movement performed by the person 8 corresponds to a predetermined and predefined sequence of two or more states and, on the basis thereof, detect the gesture.

However, other algorithms for gesture recognition are also conceivable and usable. For example, the gesture recognition algorithm can include a trained recurrent neural network, RNN.

FIG. 2 shows a schematic flowchart of an exemplary embodiment of a method according to the invention for the gesture-controlled opening of an area of the vehicle 1 closed by a movable component 3. In accordance with steps S1, S2 and S3, optionally repeated for multiple persons, an embodiment of a method according to the invention for calibrating the gesture recognition algorithm is carried out.

In particular, in step S1 the gesture recognition algorithm is provided in a computer-readable format and in step S2, while the person 8 is situated in the field of view of the ultrasonic sensor 5 and performs the gesture movement, the time-dependent sensor signal is generated. In step S3, the value of the parameter is determined and stored as a function of the sensor signal, for example by virtue of the characteristic property of the gesture movement regarding the person 8 being determined. After steps S1 to S3 have been carried out, the calibration mode is ended and the gesture recognition mode, for example, is activated at a later point in time. In step S4, while the person 8 performs the gesture movement again in the field of view of the ultrasonic sensor 5, a further sensor signal is then generated by means of the ultrasonic sensor 5, and in step S5 the gesture recognition algorithm is applied to the input data which are a function of the further sensor signal, as a function of the stored value of the parameter and the predetermined gesture is detected. In step S6, in response to the detection of the gesture, the movable component 3 is moved automatically in order to open the closed area.

As a result, a particularly robust gesture recognition can be achieved, which can recognize various types or expressions of gesture movement. The sensor signal can be fed directly to the RNN, for example, and this can make a binary decision as to whether the gesture movement corresponds to the gesture or not.

An advantage of the RNN consists in the fact that it features an internal state which acts like a memory for the previous measurements, such that changes between the measurements can be recognized. This also makes an external memory for measurement results superfluous, with the result that storage space can be saved. The RNN used can be an LSTM, for example.

The RNN can be trained using captured data in order to learn the internal parameters and to recognize when the gesture is present. It may be advantageous to tailor a pretrained

RNN to the specific model of the vehicle 1, since sensor positions and other properties can change depending on the vehicle model. This can be achieved by capturing a data set specifically with this vehicle model and further training the RNN correspondingly.

1. A method for calibrating a gesture recognition algorithm for the gesture-controlled opening of an area of a vehicle closed by a movable component, the method comprising:
providing the gesture recognition algorithm in a computer-readable format which is adapted to recognize a predetermined gesture as a function of a time-dependent sensor signal of an ultrasonic sensor of the vehicle;
generating a time-dependent first sensor signal by means of the ultrasonic sensor while a first person performs a gesture movement in a field of view of the ultrasonic sensor; and
determining a first value of a predetermined parameter of the gesture recognition algorithm and stored as a function of the first sensor signal.

2. The method as claimed in claim 1, further comprising:
determining a characteristic property of the gesture movement regarding the first person as a function of the first sensor signal; and
determining the first value of the parameter as a function of the characteristic property determined regarding the first person.

3. The method as claimed in claim 2, wherein the characteristic property comprises:
an initial spacing of a body part, moved during the gesture movement, from the ultrasonic sensor; and/or
a final spacing of the body part after or upon completion of the gesture movement; and/or
a speed of movement of the body part during the gesture movement; and/or
a time duration of the gesture movement; and/or
a maximum amplitude of a signal pulse of the first sensor signal during the gesture movement.

4. The method as claimed in claim 2, further comprising:
repeating the generation of the first sensor signal while the first person repeatedly performs the gesture movement in the field of view of the ultrasonic sensor;
repeating the determination of the characteristic property of the gesture movement regarding the first person on the basis of the repeatedly generated first sensor signal; and
determining the first value of the parameter as a function of the repeatedly determined characteristic property.

5. The method as claimed in claim 2, further comprising implementing a state machine based on the gesture recognition algorithm.

6. The method as claimed in claim 2, further comprising:
generating a time-dependent second sensor signal by means of the ultrasonic sensor while a second person performs the gesture movement in the field of view of the ultrasonic sensor;
determining the characteristic property of the gesture movement regarding the second person as a function of the second sensor signal; and
determining and storing a second value of the parameter as a function of the characteristic property determined regarding the second person.

7. The method as claimed in claim 1, wherein the gesture recognition algorithm comprises a recurrent neural network and the parameter is a weighting factor or a bias parameter of the recurrent neural network.

8. The method as claimed in claim 1, further comprising:
activating a calibration mode of an ultrasonic sensor system, which comprises the ultrasonic sensor; and
generating the first sensor signal in the calibration mode.

9. The method as claimed in claim 8, further comprising:
transmitting at least one radio signal to at least one computing unit of the ultrasonic sensor system by means of an electronic apparatus external to the vehicle; and
activating the calibration mode as a function of the transmitted at least one radio signal.

10. The method as claimed in claim 8, further comprising:
transmitting identification information of the first person to the at least one computing unit using the at least one radio signal; and
storing the first value of the parameter in a user profile of the first person as a function of the identification information.

11. The method as claimed in claim 8, further comprising activating the calibration mode as a function of a user input recorded by means of a user input apparatus of the vehicle.

12. A method for the gesture-controlled opening of an area of a vehicle closed by a movable component, the method comprising:
providing the gesture recognition algorithm in a computer-readable format which is adapted to recognize a predetermined gesture as a function of a time-dependent sensor signal of an ultrasonic sensor of the vehicle;
generating a time-dependent first sensor signal by means of the ultrasonic sensor while a first person performs a gesture movement in a field of view of the ultrasonic sensor;
determining a first value of a predetermined parameter of the gesture recognition algorithm and stored as a function of the first sensor signal;
generating a time-dependent further first sensor signal by means of the ultrasonic sensor while the first person performs the gesture movement again in the field of view of the ultrasonic sensor;
detecting a predetermined gesture as a function of the stored first value of the parameter by applying the gesture recognition algorithm to input data which are a function of the further first sensor signal; and
moving the movable component automatically in order to open the closed area in response to the detection of the gesture.

13. A device for a vehicle for the gesture-controlled opening of an area of the vehicle closed by a movable component, the device comprising:
a storage medium which stores a gesture recognition algorithm in a computer-readable format which is adapted to recognize a predetermined gesture as a function of a time-dependent sensor signal of an ultrasonic sensor (5) of the vehicle; and
an ultrasonic sensor system with an ultrasonic sensor,
wherein the ultrasonic sensor system is configured to generate a time-dependent first sensor signal by means of the ultrasonic sensor while a first person performs a gesture movement in a field of view of the ultrasonic sensor,
wherein the ultrasonic sensor system has at least one computing unit which is configured to determine and to store a first value of a predetermined parameter of a gesture recognition algorithm as a function of the first sensor signal.

14. The device as claimed in claim 13,
wherein the ultrasonic sensor system is configured, after the determination and storage of the first value of the parameter, to generate a time-dependent further first sensor signal by means of the ultrasonic sensor while the first person performs the gesture movement again in the field of view of the ultrasonic sensor,
wherein the at least one computing unit is configured to apply the gesture recognition algorithm to input data which are a function of the further first sensor signal, as a function of the stored first value of the parameter, in order to detect a predetermined gesture,
wherein the at least one computing unit is configured to generate at least one control signal to automatically move the movable component in response to the detection of the gesture.

15. (canceled)
